(19) United States
(12) Patent Application Publication
(10) Pub. No.: US 2009/0019517 A1
(43) Pub. Date: Jan. 15, 2009

(54) Method and System for Restricting Access of One or More Users to a Service

(76) Inventor: Bhavin Turakhia, Mumbai (IN)

Correspondence Address: Husch Blackwell Sanders, LLP;Welsh & Katz, 120 S RIVERSIDE PLAZA, 22ND FLOOR, CHICAGO, IL, 60606, US

(21) Appl. No.: 12/172,824

(22) Filed: Jul. 14, 2008

(30) Foreign Application Priority Data
Jul. 10, 2007 (IN) 1320/MUM/2007

(51) Int. Cl. G06F 17/00

(52) U.S. Cl. 726/1

(57) ABSTRACT

The present invention relates to method and system for restricting access of one or more users to a service provided by a service provider. The one or more users are affiliated with an entity. The method comprises providing the entity with an ability to create one or more rules for restricting access of the one or more users to the service. The one or more rules are then obtained from the entity. When a request is received from a user for accessing the service, it is identified if the request is a request to which the one or more rules are to be applied based on a first identification criterion. The one or more rules are then applied to such a request.

### FIELD OF THE INVENTION

The invention relates generally to accessing services on the Internet and specifically, to method and system for providing one or more users with restrictive access to a service.

### BACKGROUND OF THE INVENTION

Social Networking, Chat and other such services, although frequently regarded as a simple social communications service, have a significant business purpose as well. They allow collaboration and communication, via the Internet. In spite of the advantages offered to companies by Social Networking, Instant Messenger, etc, typically corporates or organizations have an issue with permitting access to these services from within a corporate network. The primary issue is that employees may spend working hours and use company resources for unofficial purposes, such as chatting with friends or looking up personal profiles, or idling time on activities that are not productive. This may lead to loss in productivity, disclosure of confidential information etc.

Companies however may wish to provide limited and restricted access to services such as social networking applications and chat applications to users within the company, which may be beneficial to the company. Typically this is done by allowing a subset of users to access certain web resources and install certain applications. However the users who are accorded this permission may also abuse their rights, for instance by adding their personal contacts such as their friends on their chat lists, or using social networking applications for gaming etc.

Hence, there is a need for method and system which allows for fine-grained control over the services that a user can access from within a company.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a block diagram of an exemplary environment for restricting access of one or more users to a service in accordance with various embodiments of the present invention.

FIG. 2 illustrates a flow diagram of a method for restricting access of one or more users to a service in accordance with an embodiment of the present invention.

FIG. 3 illustrates a block diagram depicting first identification criterion for identifying if a request for a service is one to which one or more rules are to be applied in accordance with an embodiment of the present invention.

FIG. 4 illustrates a flow diagram of a method for validating that the source Internett Protocol (IP) address is indeed in control of entity 105 in accordance with an embodiment of the present invention.

FIG. 5 illustrates a block diagram depicting a second identification criterion 330 in accordance with an embodiment of the present invention.

FIG. 6 illustrates a block diagram of a system for restricting access of one or more users to a service in accordance with an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to restricting access of one or more users to a service. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of restricting access of one or more users to a service described herein. The non-processor circuits may include, but are not limited to, a radio receiver, a radio transmitter, signal drivers, clock circuits, power source circuits, and user input devices. As such, these functions may be interpreted as steps of a method and system for restricting access of one or more users to a service. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to restricting access of one or more users to a service. The one or more users accessing the service can be affiliated to an entity such as, but not limited to, an organization, a company, an association, a legal body, a family, a household or an educational institute. Those skilled in the art will realize that affiliation with an entity can include, but is not limited to, a user being an employee of the entity, the user using network resources of the entity, etc. The service that the one or more users wish to access can be any service that is accessible through a network, such as the Internet, as provided by a server or an application installed on the one or more user's machines. For instance, the service can be, but is not limited to, a chat service, a social networking service, an application within a social network, an email service or a blog service. In one embodiment, the services maybe accessed by a user using a desktop client or a browser. In an alternate embodiment, the service may encompass only such services which involve some form of network data transfer.

The present invention deals with method that can enable the entity to create one or more rules for restricting usage of the service for the one or more users who are affiliated with the entity.

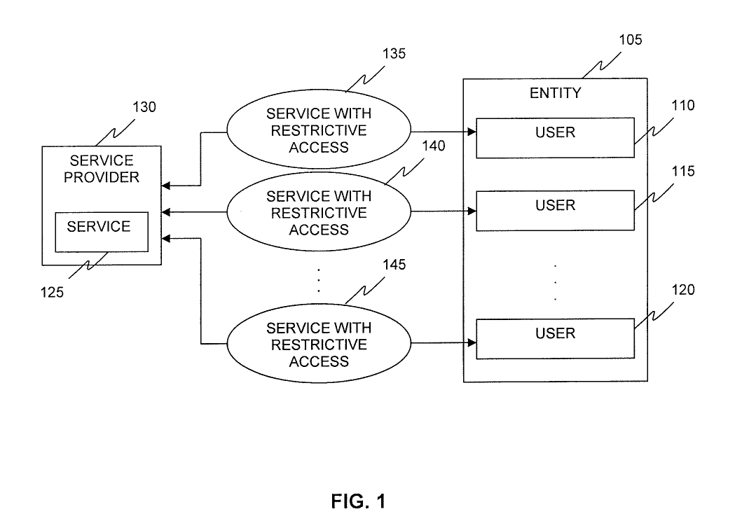

Referring now to FIG. 1, a block diagram of an exemplary environment for restricting access of one or more users to a service is shown in accordance with various embodiments of the present invention. An entity 105 may comprise of one or more users, depicted as a user 110, a user 115 and a user 120, who are affiliated with entity 105. For instance, the one or more users can be employees working for entity 105. Entity 105 may wish to give restrictive access to all the users affiliated with entity 105 or a set of users affiliated with the entity for a service 125 provided by a service provider 130. In an embodiment, user 110, user 115 and user 120 can be groups of users which are to be given similar restrictive access to service 125.

For instance, entity 105 may wish to allow the one or more users to install or access their Instant Messenger (IM) clients. However, entity 105 may want to restrict usage of the IM clients when the one or more users are accessing the IM clients from within an entity network. Entity 105 may want to allow user 110 to chat with user 120, but may not want to allow user 110 to chat with user 115. Further, entity 105 may want to allow user 110 to chat with users who are not affiliated with the entity, such as personal contacts of user 110. However, entity 105 may not want user 115 to chat with any users who are not affiliated with entity 105, when user 115 is using the entity network.

In another instance, entity 105 may want to allow the one or more users to access a social networking site, but may want to block the one or more users from accessing certain groups within the social networking site such as gaming groups etc or certain applications such as games.

The present invention allows entity 105 to create such rules to provide the one or more users with restrictive access to service 125. In general, the present invention enables entity 105 to specify rules such that user 110 can access service 125 with a restrictive access 135, user 115 can access service 125 with a restrictive access 140 and user 120 can access service 125 with a restrictive access 145. The restrictive access 135 provided to user 110, the restrictive access 140 provided to user 115 and the restrictive access 135 provided to user 120 may be different in terms of an extent to which the users' are allowed to access service 125. Those skilled in the art will realize that entity 105 may comprise any number of affiliated users. Further, entity 105 can use the method and system of present invention to restrict usage of any number of services.

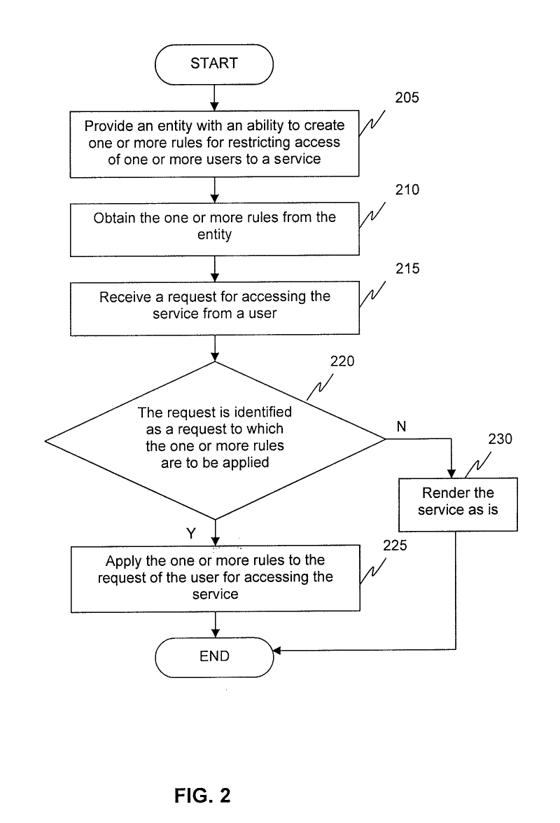

Referring now to FIG. 2, a flow diagram of a method for restricting access of one or more users to service 125 is depicted in accordance with an embodiment of the present invention. Entity 105 is provided with an ability to create one or more rules for restricting access of the one or more users to service 125, at step 205. The one or more rules can include, but are not limited to, a date for accessing service 125, a time-slot for accessing service 125, a bandwidth restriction for accessing service 125, a user whitelist comprising a list of users allowed to use service 125, a user whitelist comprising a list of users that the one or more users using service 125 are allowed to communicate with, a user blacklist comprising a list of users not allowed to use service 125, a user blacklist comprising a list of users that the one or more users using service 125 are not allowed to communicate with, a network whitelist comprising a list of networks allowed to be accessed using service 125, a network blacklist comprising a list of blocked networks disallowed to be accessed using service 125, an application whitelist comprising a list of applications allowed to be used using service 125 and an application blacklist comprising a list of blocked applications disallowed to be used using service 125.

For instance, if service 125 is MSN messenger, the service provider 130, MSN, can provide entity 105 with an ability to define a whitelist of users who are allowed to use the MSN messenger, a time slot when the users are allowed to use the MSN messenger, a blacklist of users who are not allowed to use the MSN messenger, a whitelist of users who user 110, user 115 and user 120 can chat with using the MSN messenger, a blacklist of users who user 110, user 115 and user 120 are not allowed to chat with using the MSN messenger, services within MSN messenger that are allowed to be accessed, etc.

Similarly, a social networking service may provide entity 105 with an ability to define whitelists and blacklists consisting of networks that a user can participate in, or applications that the user can use, and further within applications, the functionality that a user can access and so on.

It will be appreciated by those skilled in the art that entity 105 can be provided with an ability to create multiple rules for multiple services, and all such embodiments are within the scope of the present invention.

Once entity creates the one or more rules, service provider 130 obtains the one or more rules created by entity 105 for restricting access to service 125, at step 210. In an embodiment, an intermediate proxy server or a server of entity 105 or a client through which service 125 is being accessed can obtain the one or more rules.

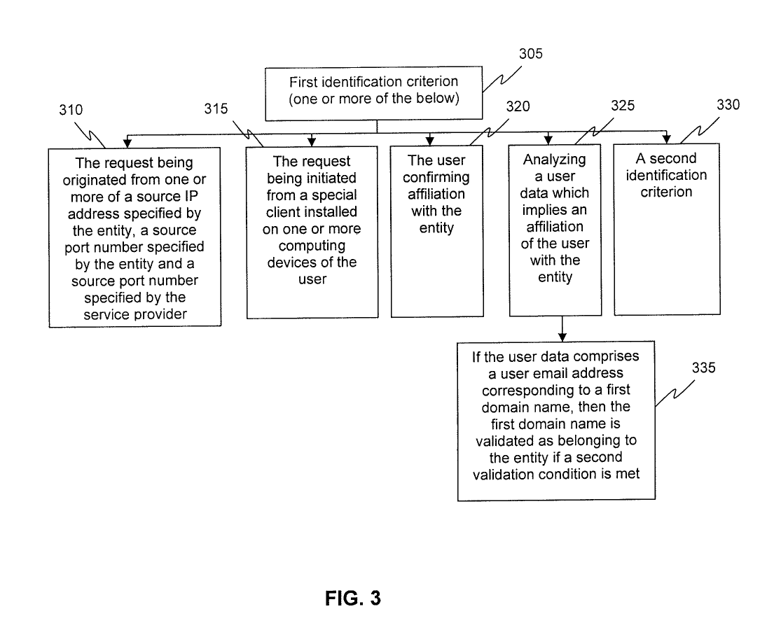

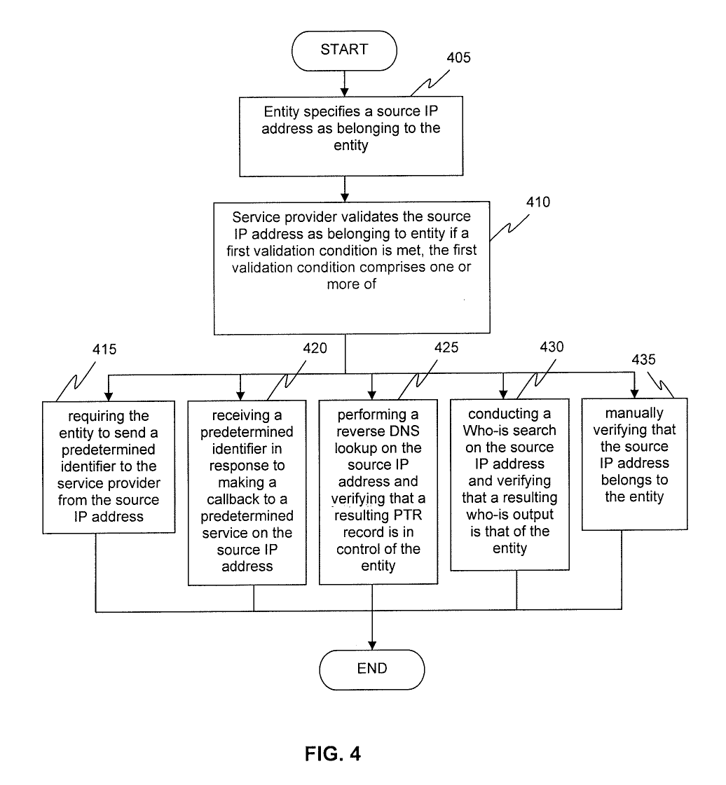

At step 215, a request is received from a user for accessing service 125. Before rendering service 125, service provider 130 identifies, at step 220, if the one or more rules are to be applied to that request. In other words, service provider 130 determines if a user affiliated with entity 105 has sent the request. In accordance with an embodiment, the identification of the request is based on a first identification criterion. The first identification criterion for identifying if the request is one to which the one or more rules are to be applied is discussed in detail in conjunction with FIG. 3 and FIG. 4.

If the request is identified as originating from user 110 of entity 105 at step 220, then the one or more rules are applied to the request of user 110 for accessing service 125, at step 225. In an embodiment of the present invention, the one or more rules can be applied in such a manner that user 110 has the restricted access to service 125 only during those times when user 110 is working within entity 105, and on other times, user 110 can enjoy unrestricted access to service 125.

For instance, if entity 105 creates a whitelist of users that user 110 can communicate with using service 125 during work hours, then service provider 130 applies these rules on the request from user 110 before rendering service 125.

If the request is not identified as one to which the one or more rules need to be applied, then service provider 130 can render service 125 as is, at step 230.

Turning to FIG. 3, a block diagram depicting a first identification criterion 305 for identifying if a request for service 125 is one to which one or more rules are to be applied, is shown in accordance with an embodiment of the present invention. First identification criterion 305 can include one or more of a condition 310, a condition 315, a condition 320, a condition 325 and a condition 330. Thus, the request can be identified as originating from the one or more users of entity 105, if any one of or a combination of condition 310, condition 315, condition 320, condition 325 and condition 330 are met.

Condition 310 includes the request being originated from one or more of a source Internet Protocol (IP) address specified by entity 105, a source port number specified by entity 105 and a source port number specified by service provider 130. Entity 105 can specify one or more source IP addresses which belong to entity 105.

In another embodiment, the source port number or such similar network endpoint is specified by service provider 130 or entity 105 for accessing service 125. Any user who connects using the source port number can be treated as originating from entity 105. Entity 105 can ensure that for accessing service 125, the general standard port on which service 125 is accessed is inaccessible to the one or more users from within the entity network and instead the one or more users are always sent to the source port number.

Those skilled in the art will appreciate that if the source IP address is unique to entity 105, the source IP address is by itself sufficient to identify that the request is originating from within the entity network. However, if the source IP address is shared among a set of entities, then one or more of a port number and a second identification criterion 330 is additionally required to identify that the request is originating from within the entity network.

Similarly, it will be appreciated that if the source port number is unique to entity 105, then the source port number is by itself sufficient to recognize requests originating from users within the entity network. However, if the source port number is shared among a set of entities, then one or more of a source IP address and second identification criterion 330 is additionally required to identify that the request is originating from within the entity network.

Service provider 130 may require validation that the one or more source IP Addresses, and/or one or more source port numbers are indeed in control of entity 105 if a first validation condition is met. Methods used for validation are described in detail in conjunction with FIG. 4.

Referring back to FIG. 3, condition 315 includes the request being initiated from a special client installed on one or more computing devices of the one or more users affiliated with entity 105. The special client can be, but is not limited to, a special browser or a special desktop client, that are specially programmed to identify requests to which restrictions should be applied and allow restrictive access to service 125. Entity 105 or service provider 130 can ensure that only the special client is installed on one or more computing devices of the one or more users of entity 105.

Condition 320 includes the user, from whom the request is received, confirming affiliation with entity 105. For instance, entity 105 can specify one or more IP addresses, and all users connecting or requesting service 125 from the one or more IP addresses can be sent a notification to approve that they are currently accessing service 125 from within the entity network. Further, subsequent requests for service 125 from such users can be treated as originating from within the entity network.

Condition 325 includes analyzing a user data provided by the user who sends the request. The user data can imply an affiliation of the user with entity 105. For instance, the user data can include a user email address. The user email address can be registered with a domain name belonging to the entity. The domain name can be validated as belonging to entity 105, at 335, if a second validation condition is met.

In one embodiment, the second validation condition includes email verification where an email address belonging to entity 105 is obtained from a Who-is query on the domain name. Entity 105 can validate that the domain name belongs to it by responding to an email sent to the email address obtained from the Who-is query.

In another embodiment, the second validation condition includes requesting entity 105 to make a modification to one or more Domain Name System (DNS) records of the domain name. If the required modification is made, then the domain name can be confirmed as belonging to entity 105. The second validation condition can also include manually verifying that the domain name belongs to the entity, for instance, by conducting a Who-is search. Any other such mechanism known in the art can be used to validate that the domain name belongs to entity 105.

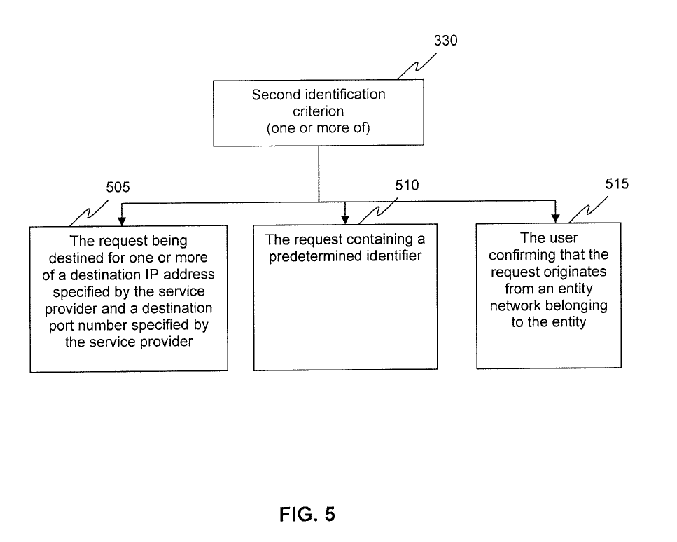

If any one or more of condition 310, condition 315, condition 320, condition 325 and condition 330 are met, then the request can be considered to be originating from the one or more users affiliated with entity 105. Condition 330, which is a second identification criterion, is described in detain in conjunction with FIG. 5.

Turing now to FIG. 4, a flow diagram of a method for validating that the source IP address is indeed in control of entity 105 is shown in accordance with an embodiment of the present invention. At 405, entity 125 specifies one or more source IP addresses as belonging to entity 125. Service provider then validates, at 410, that the source IP address indeed belong to entity 125 if a first validation condition is met.

In one embodiment, the first validation condition can be service provider 130 requiring entity 105 to send a predetermined identifier from the one or more source IP Addresses to service provider 130, at 415. The predetermined identifier can be previously exchanged between entity 105 and service provider 130.

In another embodiment, the first validation condition includes service provider 130 making a callback to a predetermined service on the one or more source IP addresses that requires entity 105 to host such a predetermined service and respond back with the predetermined identifier, at 420. The predetermined service can be uploading a specific file in a specific folder, etc.

In yet another embodiment, to the first validation condition includes performing a reverse DNS lookup on the one or more source IP addresses, at 425. It can further be verified that a resulting Pointer Record (PTR) is in control of entity 105.

Further, a Who-is search can be conducted, at 430, on the source IP address. It can be verified that a resulting who-is output is that of entity 105. Moreover, service provider 130 can also manually verify, at 435, that the one or more source IP addresses belongs to entity 105.

Those skilled in the art will realize that any one or more of 415, 420, 425, 430 and 435 can be used to validate that the source IP address and/or the source port number belongs to entity 125.

Any request received from the one or more source IP addresses can be deemed to be originating from entity 105.

Turning now to FIG. 5, a block diagram depicting a second identification criterion 330, is shown in accordance with an embodiment of the present invention. The second identification criterion can include one or more of a condition 505, a condition 510 and a condition 515. Thus, it will be obvious to those skilled in the art that the request can be identified as originating from the one or more users of entity 105, if any one of or a combination of condition 310, condition 315, condition 320, condition 325, condition 505, condition 510 and condition 515 are met.

Condition 505 includes the request being destined for one or more of a destination IP address specified by service provider 130 and a destination port number specified by service provider 130. Any user who connects to the destination port number or the destination IP address can be treated as originating from entity 105. Entity 105 can ensure that for accessing service 125, the one or more users from within the entity network connect to the destination IP address or the destination port number specified by service provider 130 only.

Those skilled in the art will appreciate that if the destination IP address is uniquely provided to entity 105, the destination IP address is by itself sufficient to identify that the request is originating from within the entity network. However, if the destination IP address is shared among a set of entities, then one or more of the source IP address or the source port number or the destination port number is additionally required. In this case, all requests originating from the source IP address and/or the source port number and destined for the destination IP address and/or destination port number can be identified as originating from entity 105.

Similarly, it will be appreciated that if the destination port number is uniquely provided to entity 105, then the destination port number is by itself sufficient to recognize requests originating from users within the entity network. However, if the destination port number is shared among a set of entities, then one or more of the source IP address or the source port number or the destination IP address is additionally required. In this case, all requests originating from the source IP address and/or the source port number and destined for the destination port number and/or the destination IP address can be identified as originating from entity 105.

Those skilled in the art will appreciate that, a combination of one or more of the source IP address, the source port number, the destination IP address and the destination port number is unique per entity and in first identification criterion 305 and second identification criterion 330 such combination is used to determine whether a request is originating from a user affiliated to the entity.

Condition 510 includes the request containing a predetermined identifier that can previously be exchanged between entity 105 and service provider 130. The predetermined identifier can confirm that the request originated from within the entity network.

Further, condition 515 includes the user confirming that the request originates from the entity network belonging to entity 105. The user can confirm this by responding to a notification from service provider 130 or entity 105.

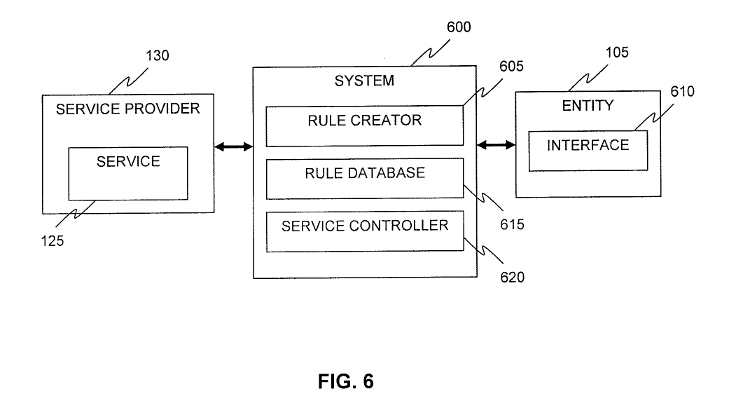

Referring now to FIG. 6, a block diagram of a system 600 for restricting access of one or more users to service 125 is shown in accordance with an embodiment of the present invention. System 600 comprises a rule creator 605 which enables entity 105 to create one or more rules for restricting access of the one or more users to service 125. In an embodiment, entity 105 can be provided with an interface 610 that enables an entity administrator to create the one or more rules for the one or more users affiliated with entity 105. Those skilled in the art will appreciate that rule creator 605 can reside on one or more of, but not limited to, service provider 130, entity 105, the one or more computing devices of the one or more users of entity 105, a server of entity 105 or an intermediate proxy server.

The one or more rules created using rule creator 605 are then obtained and stored at a rule database 615. For instance, if entity 105 wants user 110 to be able to chat with user 115 and not with user 120, then for user 110, rule database 615 can store a user whitelist comprising of user 115 and user blacklist comprising of user 120. Multiple such rules can be stored in rule database 615. Rule database 615 can reside on one or more of, but not limited to, service provider 130, entity 105, the one or more computing devices of the one or more users of entity 105, a server of entity 105 or an intermediate proxy server.

System 600 further comprises a service controller 620 which controls access to service 125. Service controller 620 can receive a request from a user for accessing service 125. Service controller 620 then needs to identify if the request is a request to which the one or more rules stored in rule database 615 are to be applied. Service controller 620 identifies this based on a first identification criterion. First identification criterion is described in detail in conjunction with FIG. 3.

Once service controller 520 identifies that the request is one to which the one or more rules are to be applied, service controller 520 fetches the one or more rules from rule database 515 and applies them to the request of the user for accessing service 125. These rules can result in allowing service 125 to a user, or disallowing service 125 to the user, or allowing limited access to service 125 for the user. Type of access permitted to a particular user is defined by entity 105 in the form of the one or more rules. These rules may also be applied within a desktop client of the user, a server or an intermediate proxy server through which these requests pass. If the rules are applied within the special client, then service provider 130 or entity 105 can ensure that one or more users of entity 105 use the special client and that the functionality of service 125 can only be accessed through such a special client

Those skilled in the art will appreciate that depiction of system 500 shown in FIG. 3 is exemplary, and any one of or a combination of rule creator 505, rule database 515 and service controller 520 can reside on one or more of, but not limited to, service provider 130, entity 105, the one or more computing devices of the one or more users of entity 105, a server of entity 105 or an intermediate proxy server.

Various embodiments of the present invention allow an entity to restrict access of a service for users affiliated with the entity. The present invention can, further, allow the entity to customize rules for a user or a group of users to access the service. Moreover, the present invention enables a service provider to identify that a request for a service is one to which one or more rules are to be applied before rendering the service.

The above mentioned advantages are merely exemplary and should not be restricted to the ones specified. Those skilled in the art shall appreciate that the advantages may be several and all such advantages are within the scope of the present invention.

What is claimed is:

1. A method for restricting access of one or more users to a service provided by a service provider, wherein the one or more users are affiliated with an entity, the method comprising:
providing the entity with an ability to create one or more rules for restricting access of the one or more users to the service;
obtaining the one or more rules from the entity;
receiving a request for accessing the service from a user;
identifying the request as a request to which the one or more rules are to be applied based on a first identification criterion, wherein the first identification criterion comprises one or more of:
the request originating from one or more of a source Internet Protocol (IP) address specified by the entity, a source port number specified by the entity and a source port number specified by the service provider;
the request initiated from a special client, wherein the special client is installed on one or more computing devices of the user;
the user confirming affiliation with the entity;
analyzing a user data provided by the user, wherein the user data implies an affiliation of the user with the entity; and
a second identification criterion;
applying the one or more rules to the request of the user for accessing the service.

2. The method of claim 1 wherein the one or more users comprises one or more of an individual user and a group of users.

3. The method of claim 1, wherein the service is one or more of a chat service, a social networking service, an application within a social network, an email service, and a blog service.

4. The method of claim 1, wherein the entity is one or more of an organization, a company, an association, a legal body, a family, a household and an educational institute.

5. The method of claim 1, wherein the one or more rules comprises one or more of a date for accessing the service, a time-slot for accessing the service, a bandwidth restriction for accessing the service, a first user whitelist comprising a list of users allowed to use the service, a second user whitelist comprising a list of users that the one or more users using the service are allowed to communicate with, a first user blacklist comprising a list of users not allowed to use the service, a second user blacklist comprising a list of users that the one or more users using the service are not allowed to communicate with, a network whitelist comprising a list of networks allowed to be accessed using the service, a network blacklist comprising a list of blocked networks disallowed to be accessed using the service, an application whitelist comprising a list of applications allowed to be used using the service and an application blacklist comprising a list of blocked applications disallowed to be used using the service.

6. The method of claim 1, wherein the source IP address is validated as belonging to the entity if a first validation condition is met, the first validation condition comprising one or more of:
requiring the entity to send a predetermined identifier to the service provider from the source IP address;
receiving a predetermined identifier in response to making a callback to a predetermined service on the source IP address;
performing a reverse Domain Name System (DNS) lookup on the source IP address and verifying that a resulting PTR record is in control of the entity;
conducting a Who-is search on the source IP address and verifying that a resulting who-is output is that of the entity; and
manually verifying that the source IP address belongs to the entity.

7. The method of claim 1, wherein the user data comprises at least a user email address, the user email address corresponding to a first domain name belonging to the entity, wherein the first domain name is validated as belonging to the entity if a second validation condition is met, the second validation condition comprising one or more of:
email verification, wherein an email address of the entity is obtained from a Who-is query on the first domain name;
requesting the entity to make a modification to one or more DNS records of the first domain name; and
manually verifying that the first domain name belongs to the entity.

8. The method of claim 1, wherein the second identification criterion comprises one or more of:
the request being destined for one or more of a destination IP address specified by the service provider and a destination port number specified by the service provider;
the request containing a predetermined identifier; and
the user confirming that the request originates from an entity network, the entity network belonging to the entity.

9. The method of claim 8, wherein a combination of one or more of the source IP address, the source port number, the destination IP address and the destination port number is unique for the entity.

10. The method of claim 8, wherein a destination comprising of one or more of the destination IP address and the destination port number, is unique per one or more of the entity, the source IP address, and the source port number.

11. The method of claim 8, wherein the user confirms that the request originates from the entity network by responding to a notification from the service provider.

12. A system for restricting access of one or more users to a service provided by a service provider, wherein the one or more users are affiliated with an entity, the system comprising:
a rule creator, wherein the rule creator enables the entity to:
create one or more rules for restricting access of the one or more users to the service;
a rule database, the rule database configured to:
obtain the one or more rules from the rule creator; and
store the one or more rules;
a service controller, the service controller controlling access to the service, the service controller configured to:
receive a request from a user for accessing the service;
identify the request as a request to which the one or more rules specified by the entity, are to be applied based on a first identification criterion, wherein the first identification criterion comprises one or more of:
the request originating from one or more of a source IP address specified by the entity, a source port number specified by the entity, a source port number specified by the service provider;
the request initiated from a special client, wherein the special client is installed on one or more computing devices of the user;
the request originating from the user, the user having confirmed an affiliation with the entity;
the request originating from the user, the user having been flagged as affiliated with the entity based on a user data provided by the user, wherein the user data implies an affiliation of the user with the entity; and
a second identification criterion;
fetch the one or more rules from the rule database;
apply the one or more rules to the request of the user for accessing the service.

13. The system of claim 12, wherein one or more of the rule creator, the rule database and the service controller reside on at least one of one or more servers of the service provider providing the service, one or more user computing machines of the one or more users affiliated with the entity, a server of the entity and an intermediate proxy server.

14. The system of claim 12 further comprises an interface, the interface enabling an entity administrator to create the one or more rules for the one or more users affiliated with the entity.

15. The system of claim 12, wherein the service controller validates the source IP address as belonging to the entity if a first validation condition is met, the first validation condition comprising one or more of:
requiring the entity to send a predetermined identifier to the service provider from the source IP address;
receiving a predetermined identifier in response to making a callback to a predetermined service on the source IP address;
performing a reverse DNS lookup on the source IP address and verifying that a resulting PTR record is in control of the entity;
conducting a Who-is search on the source IP address and verifying that a resulting who-is output is that of the entity; and
manually verifying that the source IP address belongs to the entity.

16. The system of claim 12, wherein the user data comprises at least a user email address, the user email address corresponding to a first domain name belonging to the entity, wherein the service controller validates the first domain name as belonging to the entity if a second validation condition is met, the second validation condition comprising one or more of:
email verification, wherein an email address of the entity is obtained from a Who-is query on the first domain name;
requesting the entity to make a modification to the DNS records of the first domain name; and
manually verifying that the first domain name belongs to the entity.

17. The system of claim 12, wherein the second identification criterion comprises one or more of:
the request being destined for one or more of a destination IP address specified by the service provider and a destination port number specified by the service provider;
the request containing a pre-determined unique identifier; and
the user confirming that the request originates from an entity network, the entity network belonging to the entity.

18. The system of claim 17, wherein the user confirms that the request originates from the entity network by responding to a notification from the service controller.
